(19) United States
(12) Patent Application Publication
(10) Pub. No.: US 2005/0164729 A1
(43) Pub. Date: Jul. 28, 2005

(54) Method for providing seamless mobility to a mobile node in an optimized fashion

(76) Inventors: Vidya Narayanan, Schaumburg, IL (US); Cynthia M. Jung, Menlo Park, CA (US); Adam C. Lewis, Buffalo Grove, IL (US)

Correspondence Address: MOTOROLA, INC., 1303 EAST ALGONQUIN ROAD, IL01/3RD, SCHAUMBURG, IL, 60196, US

(21) Appl. No.: 10/767,127

(22) Filed: Jan. 28, 2004

(51) Int. Cl. H04Q 7/24; H04Q 7/20

(52) U.S. Cl. 455/522; 370/338

(57) ABSTRACT

A method for providing seamless mobility to a first device (102) in a system (100) comprising at least the first device, a second device (104/106) and a routing infrastructure (108) is disclosed herein. The routing infrastructure comprises a plurality of routers used to communicate information between the first device and the second device. In operation, the first device receives an anycast address and injects an updated route to the anycast address into the routing infrastructure each time the first device roams to a different subnet. The first device sends a binding update to the second device informing the second device of the anycast address, after which, the first device receives information from the second device via the anycast address regardless of a location of the first device in the system.

### FIELD OF THE INVENTION

The present invention relates generally to a method for providing seamless mobility to a mobile node in an optimized fashion, particularly, by assigning an anycast address to the mobile node.

### BACKGROUND OF THE INVENTION

Seamless mobility for mobile nodes that roam from one location to another is becoming increasingly important. Mobile IP attempts to provide the much needed seamless mobility, but not without some concerns. In standard mobile internet protocol (IP), a mobile node is assigned a care-of-address (CoA) upon roaming to a foreign subnet. Once the mobile node is assigned a CoA, the mobile node sends binding updates to its home agent and all correspondent nodes informing them of its CoA. Once a correspondent node has the CoA of the mobile node, the correspondent node sends data packets to the mobile node via its CoA.

A disadvantage to standard mobile IP is that every time the mobile node roams to a new location (i.e., a different foreign subnet), the mobile node is assigned a new CoA. Upon assignment of each new CoA, the mobile node must send subsequent binding updates to its home agent and all correspondent nodes in order for these entities to contact the mobile node.

More specifically, in the case of mobile IPv4 (MIPv4), the mobile node updates the home agent with its new CoA and all subsequent data packets from correspondent nodes to the mobile node are routed through the home agent. This method causes undesirable triangular routing. Mobile IPv6 attempts to solve the disadvantages of MIPv4 by directly updating the correspondent nodes with the new CoA. A disadvantage to this is that the mobile node is now required to update every single correspondent node with its new CoA every time it roams. As such, the solution does not scale well since there may potentially be a significant number of binding updates required to be sent by the mobile node.

Moreover, handoffs from one location (foreign subnet) to another take longer when the home agent and/or the correspondent node are “several hops away” because it takes longer for the home agent and/or the correspondent node to receive subsequent binding updates from the mobile node informing them of its new CoA. Thus, the handoff is complete only when the home agent and all the correspondent nodes have been updated with the new CoA for the mobile node.

Thus, there exists a need for providing seamless mobility for mobile nodes in an optimized fashion.

### BRIEF DESCRIPTION OF THE FIGURES

A preferred embodiment of the invention is now described, by way of example only, with reference to the accompanying figures in which:

FIG. 1 illustrates a system diagram wherein the mobile node injects a unicast route to its anycast care-of-address (ACoA) into the routing infrastructure in accordance with a first example of the present invention;

FIG. 2 illustrates the system diagram of FIG. 1 wherein the mobile node sends a binding update to its home agent in accordance with the first example of the present invention;

FIG. 3 illustrates the system diagram of FIG. 1 wherein a correspondent node sends data packet(s) to the mobile node in a non-optimized fashion via its home IP address in accordance with the first example of the present invention;

FIG. 4 illustrates the system diagram of FIG. 1 wherein the mobile node sends a binding update to correspondent node in accordance with the first example of the present invention;

FIG. 5 illustrates the system diagram of FIG. 1 wherein the correspondent node sends data packet(s) to the mobile node in an optimized fashion via its ACoA in accordance with the first example of the present invention;

FIG. 6 illustrates the system diagram of FIG. 1 wherein the mobile node roams to a different foreign subnet in accordance with the first example of the present invention;

FIG. 7 illustrates the system diagram of FIG. 1 wherein the correspondent node sends subsequent data packet(s) to the mobile node in an optimized fashion at its new location via its ACoA in accordance with the first example of the present invention;

FIG. 8 illustrates a system diagram wherein the mobile node injects a unicast route to its anycast home address (AHAD) into the routing infrastructure in accordance with a second example of the present invention; and

FIG. 9 illustrates the system diagram of FIG. 8 wherein the correspondent node sends data packet(s) to the mobile node in an optimized fashion via its AHAD in accordance with a second example of the present invention.

### DETAILED DESCRIPTION OF THE PREFERRED EMBODIMENT

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

The present invention allows the use of an anycast address (e.g., an anycast IP address) for mobility by providing an anycast care-of-address (“ACoA”) or an anycast home address (“AHAD”) to be assigned to a mobile node (host or router). The ACoA and AHAD are topologically independent, thus allowing for inherent mobility via the injection of a route to the ACoA or AHAD into the routing infrastructure, and thus minimizing signaling in the network and reducing the handoff latency. Wireless mobile nodes do not have to compromise on reliability over-the-air as an anycast address is a unicast address, except that the anycast address remains the same even though the anycast address may be topologically incorrect. Let us now discuss the present invention in detail.

When the mobile node first roams away from home (or upon power up), the mobile node is assigned an ACoA, or alternatively, the mobile node is assigned an AHAD upon power up. Upon roaming, the mobile node injects a unicast route to its ACoA (or AHAD) into the network from any new point of attachment; each time the mobile node roams to a new point of attachment, the mobile node injects a new unicast route into the network to its ACoA (or AHAD) and purges the old (previous) unicast route. As a result, the routers in the infrastructure are aware of the current route to the mobile node via its ACoA (or AHAD). The home agent, if present in the network, and all correspondent nodes communicate with the mobile node via its ACoA (or AHAD), once assigned. As such, since the network always has the correct route for the mobile node via its ACoA (or AHAD), packets destined for the mobile node never have to be routed through the home agent. Further, the mobile node has to update the home agent and the correspondent nodes with its ACoA (or AHAD) only once since the ACoA (or AHAD) remains constant for the duration the mobile node is powered on.

For mobile networks, if the mobile node roams and attaches to a mobile router, the mobile router may aggregate the unicast routes to all the mobile nodes attached to it so that the number of unicast routes to individual ACoAs (or AHADs) injected into the network is minimized. In this scenario, the mobile router, like the mobile node, is assigned an ACoA (or AHAD). To accomplish the aggregation of unicast routes, the mobile router injects a route into the network to the anycast subnet on which the ACoAs (or AHADs) of the mobile router and all the mobile nodes attached to it reside. If needed, the mobile router could proxy mobility for a mobile node attached to it if the mobile node is not capable of mobile IP; the mobile node can be provisioned to use the ACoA (or AHAD) of the mobile router in this case.

When a mobile node that is attached to a mobile router roams away from the mobile router, the mobile node injects a more specific unicast route to its ACoA (or AHAD) into the network, which overrides the route to the anycast subnet injected by the mobile router. As a result, packets destined to the mobile node are routed directly to the mobile node via its ACoA (or AHAD) rather than indirectly via the mobile router and the anycast subnet.

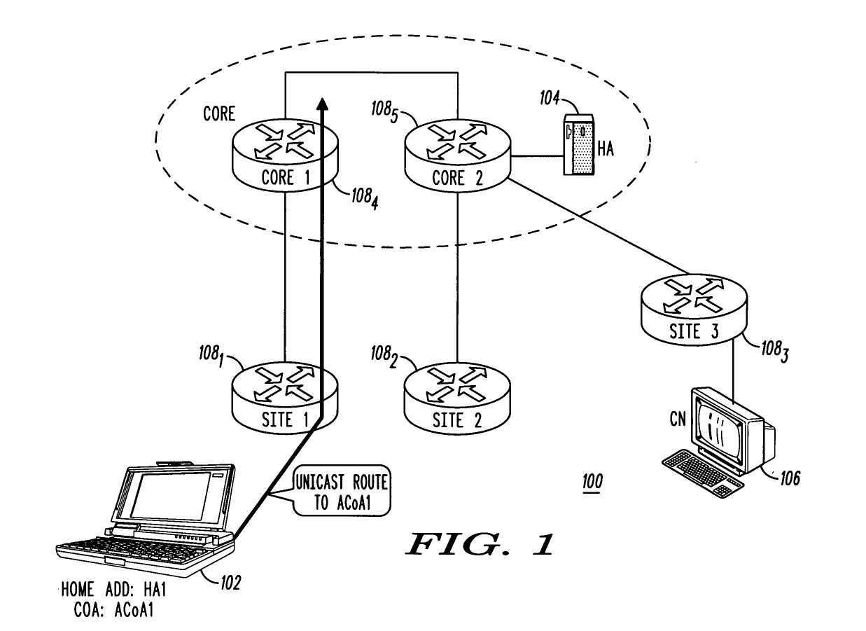

Let us now look at some examples of the present invention. FIG. 1 illustrates a topology of the system in accordance with the present invention. The system 100 comprises a mobile node 102, a home agent 104, a correspondent node 106, and a routing infrastructure interconnected through core and site routing entities 108ₙ. It should be noted that while the system 100 depicts only one mobile node 102, one home agent 104, one correspondent node 106, and five routers, a practical system might include a plurality of each.

In this example, upon the mobile node 102 detecting that it has roamed and attached to a foreign subnet, the mobile node 102 requests a care-of-address from a site router 108₁ in which it is currently attached. The site router 108₁ allocates an ACoA to the mobile node 102 and communicates the ACoA to the mobile node 102. Upon receipt, the mobile node 102 injects a unicast route to its ACoA into the routing infrastructure. The unicast route is propagated to the all the routers 108ₙ in the infrastructure via routing protocol updates. There are numerous routing protocols that may be implemented in the present invention that are well known to individuals ordinarily skilled in the art of standard IP.

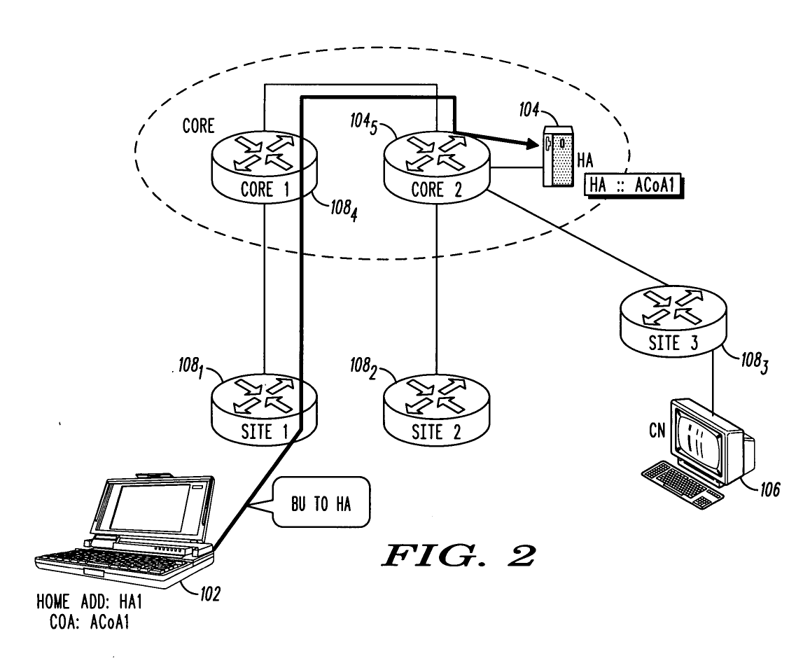

As illustrated in FIG. 2, the mobile node 102 also sends a binding update to its home agent 104 informing the home agent 104 of its ACoA. Upon receipt of the binding update, the home agent 104 creates a table entry binding the ACoA of the mobile node 102 to the home EP address of the mobile node 102.

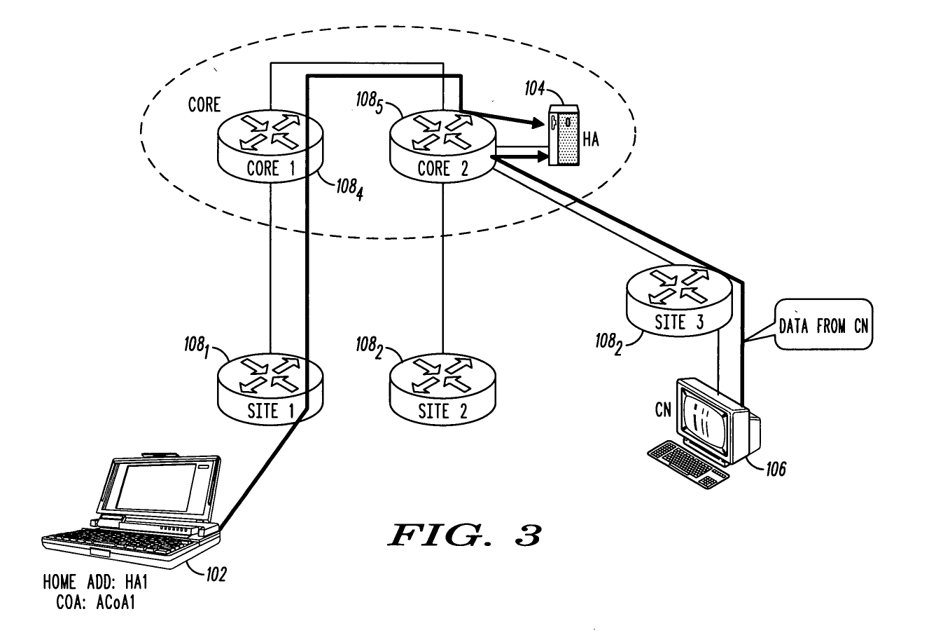

In this example, a correspondent node 106 desires to transmit data to the mobile node 102 as illustrated in FIG. 3. Since the correspondent node 106 is not aware that the mobile node 102 has roamed to a foreign subnet (i.e., that the mobile node is mobile), the correspondent node 106 sends the data packet(s) to the mobile node 102 via its home IP address through native IP. Through native IP, the data packet(s) from the correspondent node 106 reaches the home subnet of the mobile node 102, where the home agent 104 intercepts the data packet(s). The home agent 104 identifies that the data packet(s) is intended for the mobile node 102, matches the home IP address to an entry in the binding table, encapsulates the data packet(s), and tunnels the data packet(s) to the ACoA for the mobile node 102 that is routed through native IP. When the data reaches the mobile node 102, the mobile node 102 decapsulates the data packet by removing the care-of-address header and verifies that the inner header matches its home IP address, at which point the mobile node 102 processes the data packet(s).

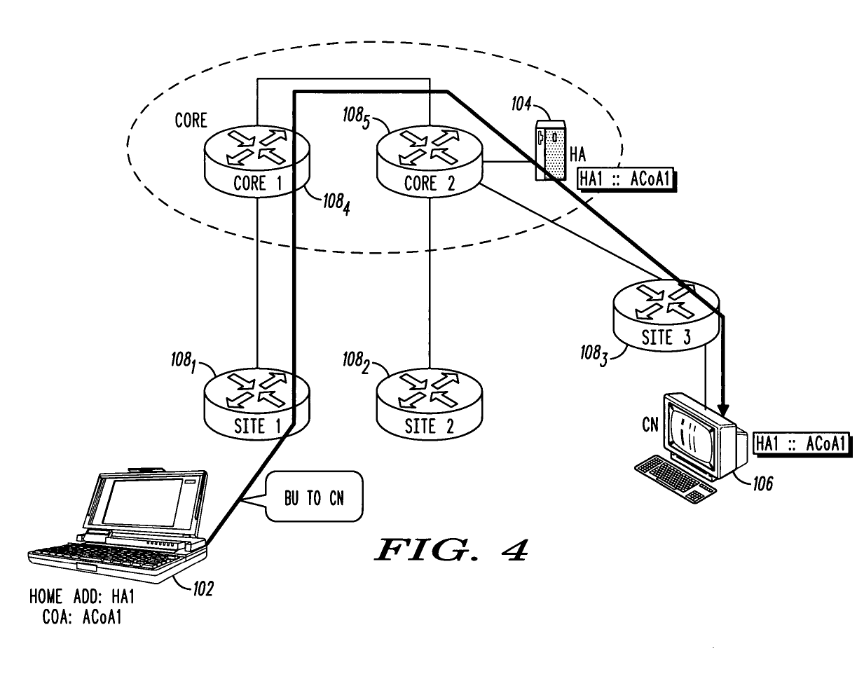

In the case of IPv6, or IPv4 when route optimization is enabled, the mobile node 102, upon detecting that the data packet was sent in a non-optimized fashion (i.e., through it home IP address), the mobile node 102 generates and sends a binding update to the correspondent node 106 as illustrated in FIG. 4. Upon receiving the binding update, the correspondent node 106 adds an entry into its binding cache that binds the home IP address of the mobile node 102 to the ACoA of the mobile node 102.

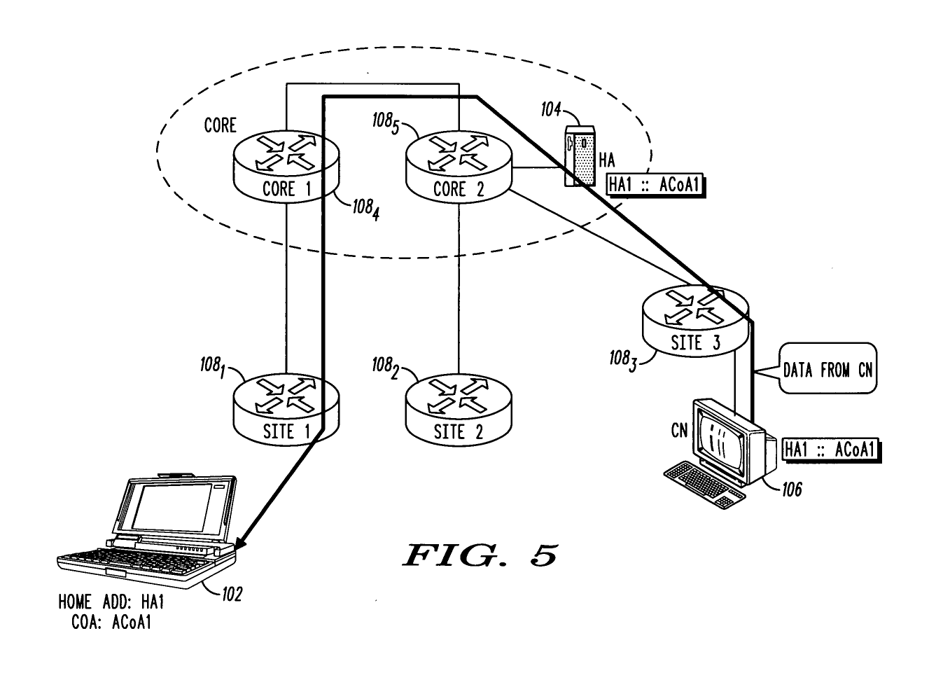

Thus, the correspondent node 106, upon generating subsequent data packet(s) for the mobile node 102, searches its binding cache and sends the data packet(s) directly to the mobile node 102 via its ACoA as illustrated in FIG. 5. Having the correspondent node 106 send the data packet(s) to the mobile node 102 via its ACoA, rather than via its home IP address, the data packet(s) bypass the home agent and reach the mobile node 102 in an optimized fashion.

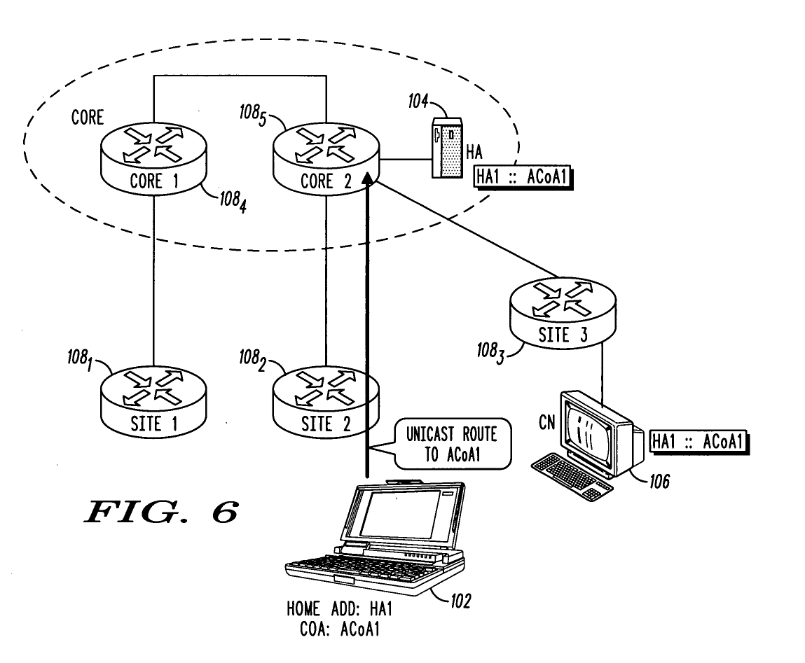

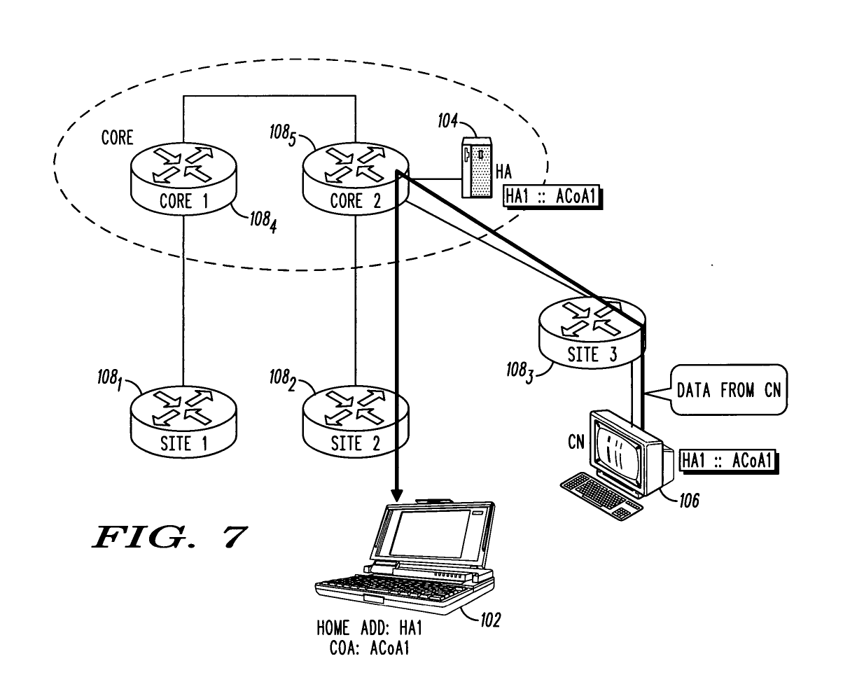

In this example, the mobile node 102 now roams to another foreign subnet 108₂ as illustrated in FIG. 6. When the mobile node 102 detects its attachment to a new foreign subnet 108₂, the mobile node 102 injects a new unicast route to its ACoA into the routing infrastructure as described above. Since the ACoA for the mobile node 102 is topologically independent, the mobile node 102 does not acquire a new care-of-address upon roaming to a different foreign subnet. Hence, because a new care-of-address is not required, the mobile node 102 does not need to send a subsequent binding update(s) to its home agent 104 and/or to the correspondent node 106, thus minimizing signaling in the system. Moreover, in the majority of cases, especially in star or mesh topologies, because the injection of the unicast route to the ACoA into the routing infrastructure by the mobile node 102 only travels one hop (to the attached site router), the present invention greatly reduces latency in handover. Moreover, when a mobile node 102 moves from one foreign subnet 108₁ to another foreign subnet 108₂, only the routers in the paths between the old and new site routers need to be updated with the route to the ACoA of the mobile node 102 (in this example, only routers 108₁, 108₂, 108₄, and 108₅ are updated with the new unicast route). Thus, the correspondent node 106 continues to send data packet(s) to the mobile node 102 via its ACoA in an optimized fashion as described above, and the routing infrastructure routes the data packet(s) to the mobile node 102 at its new location on its new foreign subnet 108₂ as illustrated in FIG. 7; once the ACoA is assigned to the mobile node 102, the new location of the mobile node 102 is transparent to the home agent 104 and the correspondent node 106.

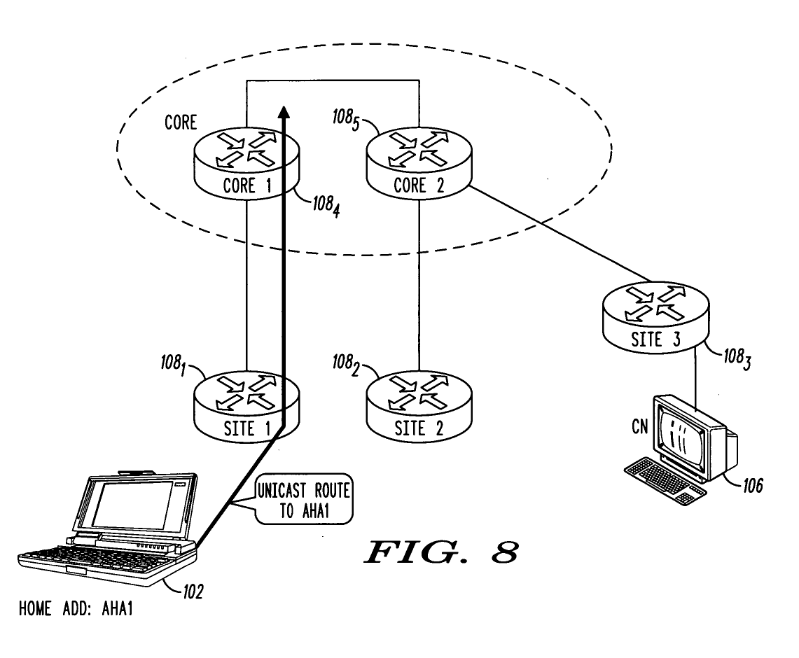

In an alternative embodiment, the mobile node 102 may be pre-configured with an AHAD, or the mobile node 102 may dynamically acquire the AHAD upon power up (e.g., via a dynamic host configuration protocol (DHCP)). As with the ACoA, the AHAD is also topologically independent. In the alternative embodiment, however, the correspondent node 106 knows the AHAD of the mobile node a priori. It is important to note that the alternative embodiment of the present invention eliminates the need for standard mobile IP as illustrated in FIG. 8. As such, there is no home agent or foreign agent(s) present in the system (however, the presence of a home agent or foreign agent in the system does not affect the present invention), and since the correspondent node 106 knows the AHAD of the mobile node 102 a priori, binding updates are not required; the correspondent node 106 always sends data packet(s) to the mobile node 102 via its AHAD. Further, there is no triangular routing since all correspondent nodes 106 always use the AHAD of the mobile node 102 irrespective of the locations of the mobile node 102 and irrespective of whether IPv4 or IPv6 is used; thus, the data packet(s) are always routed to the mobile node 102 in an optimized fashion.

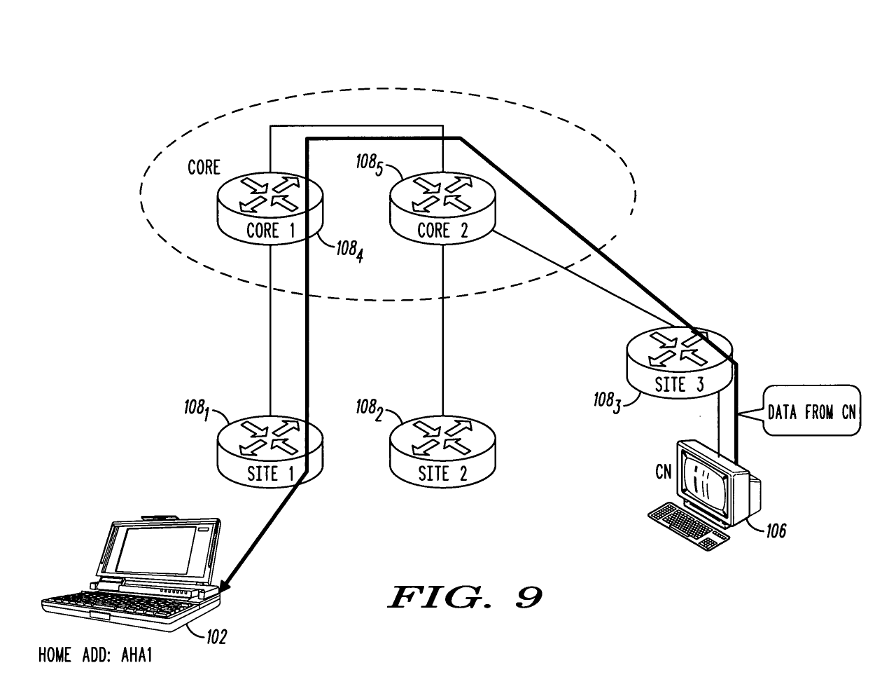

The alternative embodiment is very similar to the preferred embodiment. Upon power up and roaming to new sites, the mobile node 102 injects a unicast route to its AHAD into the routing infrastructure as illustrated in FIG. 8. Since the correspondent node 106 knows the AHAD of the mobile node a priori, when the correspondent node 106 desires to send data to the mobile node 102, the data packets are routed directly to the mobile node 102 in an optimized fashion via its AHAD as illustrated in FIG. 9.

Thus, the present invention simplifies vertical handoffs for the mobile node 102; the mobile node 102 can source on any subnet with the same anycast address without the need for a topologically correct source address. Moreover, the anycast address remains constant for the duration the mobile node 102 is powered on, thus eliminating the need for subsequent binding updates to the home agent 104, if present, and correspondent nodes 104 when the mobile node 102 roams. It is important to note that the use of anycast for mobility does not preclude devices running native mobile IP from being on the same network.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

1. In a system comprising at least a first device, a second device and a routing infrastructure comprising a plurality of routers used to communicate information between the first device and the second device, a method comprising the steps of:
at the first device:
receiving an anycast address;
injecting an updated route to the anycast address into the routing infrastructure each time the first device roams to a different subnet;
sending a binding update to the second device informing the second device of the anycast address; and
receiving information from the second device via the anycast address regardless of a location of the first device in the system.

2. The method of claim 1 wherein the anycast address is topologically independent.

3. The method of claim 1 wherein the anycast address remains constant while the first device is powered on.

4. The method of claim 1 wherein the second device is a home agent for the first device.

5. The method of claim 1 wherein the second device is a correspondent device in the system.

6. The method of claim 1 wherein the step of receiving an anycast address is performed when the first device is powered on.

7. The method of claim 1 wherein the step of receiving an anycast address is performed when the first device roams to a first foreign subnet.

8. The method of claim 1 wherein the anycast address is an anycast care-of-address.

9. The method of claim 1 wherein the anycast address is an anycast home address.

10. The method of claim 1 wherein the location of the first device is transparent to the second device.

11. The method of claim 1 further comprising the steps of:
attaching to a mobile router; and
receiving information from the second device via an address assigned to the mobile router.

12. The method of claim 11 further comprising the steps of:
de-attaching from the mobile router;
attaching to a new subnet;
injecting an updated route to the anycast address into the routing infrastructure; and
receiving information from the second device via the anycast address.
